(19) United States
(12) Patent Application Publication
(10) Pub. No.: US 2015/0014163 A1
(43) Pub. Date: Jan. 15, 2015

(54) stop for sealing a housing of an exhaust gas sensor, exhaust gas sensor, and exhaust gas sensor production

(71) Applicant: ROBERT BOSCH GMBH, Stuttgart (DE)

(72) Inventors: Guido Soyez, Ludwigsburg (DE); Frank Stanglmeier, Eberdingen-Hochdorf (DE); Jens Schneider, Leonberg (DE); Eckart Reihlen, Engels (RU)

(73) Assignee: Robert Bosch GmbH, Stuttgart (DE)

(21) Appl. No.: 14/377,760

(22) PCT Filed: Nov. 29, 2012
(86) PCT No.: PCT/EP2012/073891

§ 371 Date: Aug. 8, 2014

(30) Foreign Application Priority Data
Feb. 9, 2012 (DE) 10 2012 201 901.4

(51) Int. Cl. G01N 27/407; F01N 11/00; G01N 27/406; F16J 15/02

(52) U.S. Cl. CPC G01N 27/4078; F16J 15/022; F01N 11/007; G01N 27/4065
USPC 204/406; 277/627; 156/306.6

(57) ABSTRACT

A stopper for sealing a housing of an exhaust gas sensor has: at least one axial through-channel for guiding through a connecting cable; a basic body that has a fluoroelastomer; and at least one outer seal situated radially externally on the stopper and having at least one thermoplastically processable fluoropolymer-containing material having a melting point or melting range between 170° C. and 320° C.

### BACKGROUND OF THE INVENTION

1. Field of the Invention

The present invention relates to an exhaust gas sensor including: a housing in which there is situated a sensor element that is for example made of ceramic and that operates electrochemically; and a stopper that seals the housing and through which at least one connecting cable is led out from the housing or led into the housing.

2. Description of the Related Art

One demand made on this stopper, and on the interaction of the stopper with the housing, is that of a high degree of tightness. The high tightness effectively and permanently prevents damaging—for example, corrosion-causing—liquids and gases from penetrating into the interior of the exhaust gas sensor. In order to realize the tightness, the stopper is in particular required to have sufficient elasticity. Due to the high exhaust gas temperatures to which the exhaust gas sensor is exposed, only materials having a correspondingly high temperature resistance can be used for the stopper.

From published German patent application document DE 10 2008 044 159 A1, it is known to provide a stopper made of a fluoroelastomer to seal the housing of an exhaust gas sensor. It is also known to use caulking to achieve a sealing effect between the stopper and the housing, or a sealing effect between the stopper and the connecting cable.

When new, fluoroelastomers have a high degree of elasticity, so that at first a good seal is possible through the sealing of the housing of the exhaust gas sensor with the fluoroelastomer stopper, with a non-positive fit. However, if the exhaust gas sensor is exposed to excessively high temperatures over an impermissibly long period of time, the material becomes brittle, in particular due to the diffusion out of softening components from the fluoroelastomer, and/or through other mechanisms that change the elastomer, and this brittleness results in a decrease in elasticity. Due to the thus decreased sealing effect of the fluoroelastomer stopper, undesirable liquids and gases, for example ones that cause corrosion, can enter into the interior of the exhaust gas sensor and impair its functioning.

For this reason, the permissible temperature loading of conventional sensors with regard to the magnitude and duration of the temperature loading is subject to specified limits, and the object of the present invention is to overcome these limits.

### BRIEF SUMMARY OF THE INVENTION

According to the present invention, the stopper has a basic body that includes polytetrafluoroethylene (PTFE). Although, in the context of the present invention, the term “basic body” is not to be understood as being excessively limiting, it is nonetheless preferable that the basic body of the stopper have the shape, or basic shape, of a right circular cylinder, or is similar thereto or based thereon. For example, in this context, starting from the shape, or the basic shape, it is possible to carry out chamfering, rounding, or the like, and/or deformations, for example plastic and/or elastic deformations.

Here, a fluoroelastomer is fundamentally understood in particular as fluororubbers (FKM) and/or perfluororubbers (FFKM), tetrafluoroethylene/propylene rubbers (FEPM), and/or fluorinated silicone rubbers. Preferable, however, are fluoroelastomers having high temperature resistance, for example those that can be exposed at least briefly to temperatures of 250° C. and higher without chemical decomposition, in particular fluororubbers (FKM) and/or perfluororubbers (FFKM).

Preferably the basic body makes up at least 80%, or at least 85%, preferably even at least 90% or at least 95%, of the mass of the stopper. In addition or alternatively it can also be advantageous if the basic body makes up at least 65% or at least 72%, preferably even at least 79% or at least 86%, of the volume of the stopper.

Although the basic body contains only a certain portion of a fluoroelastomer, even only with regard to a spatial part and/or with regard to its chemical composition, it is nonetheless preferred that the basic body be made up at least 95%, or completely, of a fluoroelastomer, and/or that the basic body be made up of a fluoroelastomer.

According to the present invention, the stopper has at least one axial through-channel for leading through at least one connecting cable. Relative for example to a cylindrical or cylinder-like shape or basic shape of the basic body, an axial through-channel is to be understood as meaning that the through-channel passes through the two oppositely situated end faces of the stopper, and/or that the through-channel does not pass through the in particular radially outwardly situated jacket surface of the stopper. Although the present invention is not limited thereto, it is nonetheless preferred that the through-channel runs parallel to an axis of symmetry of the basic body, or that an axis of symmetry of the basic body coincides with an axis of symmetry of the through-channel. A configuration of a plurality of through-channels, in particular two, three, four, five, or six through-channels, is also possible, these preferably being situated symmetrically about an axis of symmetry of the basic body. Although the provision of exactly one connecting cable per through-channel is preferred, in principle it is also possible to provide in a through-channel a plurality of connecting cables or a bundle of for example glued and/or welded connecting cables that includes a plurality of connecting cables.

According to the present invention, the stopper includes an outer seal that is situated radially outwardly on the stopper or on the basic body. This outer seal is preferably suitable for closing, in particular sealing, particularly preferably with a material bond, a gap that remains between the basic body of the stopper and a housing of an exhaust gas sensor. Although it is possible and preferred that the outer seal covers the outer contour of the basic body, in particular predominantly or completely, it is also possible and preferred that the outer seal be situated only at some positions radially outwardly on the stopper or on the basic body, i.e. that parts of the outer contour of the basic body remain open and are suitable for being situated immediately opposite the housing of an exhaust gas sensor.

The present invention is based on the recognition that due to the material that it includes or of which it is made, namely a fluoroelastomer, the basic body when new has good elastic properties, and is therefore suitable in principle for transmitting a force or a state of tension, but that these elastic properties degrade under ongoing exposure to high temperatures. In addition, it has been recognized that a material seal externally on the stopper requires the provision of an additional outer sealing, because fluoroelastomers, due to their absent or inadequate thermoplastic properties, are not suitable for forming a material closure. The present invention is based on the recognition that in order to realize an improved sealing effect in the area of the outer seal, the selection of the material of the outer seal is particularly important.

According to the present invention, and based on the above-named considerations, trials carried out by applicant have identified thermoplastically processable fluoropolymers having a melting point or melting range between 170° C. and 320° C. as suitable for the outer seal.

In particular, the materials perfluoroalkoxy polymer (PFA) and tetrafluoroethylene perfluoropropylene (FEP) were identified as suitable. Also identified as suitable were the materials polychlorotrifluoroethylene (PCTFE) and polyvinylidene fluoride (PVDF). In addition to their thermoplastic processability, these materials have in common that they are suitable for wetting ceramic, oxidic, glass, and/or metal surfaces. The material polytetrafluoroethylene (PTFE) was identified in particular as unsuitable, because it is neither thermoplastically processable, nor does it wet ceramic, oxidic, glass, or metal surfaces.

However, due to their somewhat lower temperature resistance in comparison with perfluoroalkoxy polymer (PFA) and tetrafluoroethylene perfluoropropylene (FEP), the materials polychlorotrifluoroethylene (PCTFE) and polyvinylidene fluoride (PVDF) are to be provided in particular only for use at lower temperatures (for example below 210° C.) The use of perfluoroalkoxy polymer (PFA) and/or tetrafluoroethylene perfluoropropylene (FEP) is the preferred solution in particular for high temperatures of use (for example temperatures up to 280° C. or even up to 305° C.)

Although it is preferred that the outer seal be made of perfluoroalkoxy polymer (PFA) or tetrafluoroethylene perfluoropropylene (FEP) or polychlorotrifluoroethylene (PCTFE) or polyvinylidene fluoride (PVDF) or of a mixture of these substances, or is made up of at least 95%, or completely, of perfluoroalkoxy polymer (PFA) or tetrafluoroethylene perfluoropropylene (FEP) or polychlorotrifluoroethylene (PCTFE) or polyvinylidene fluoride (PVDF) or a mixture of these substances, the present invention in principle also includes seals that have only a part made up of these materials, or that are made up of a material that has only a portion, in particular a predominant portion, of perfluoroalkoxy polymer (PFA) and/or tetrafluoroethylene perfluoropropylene (FEP) and/or polychlorotrifluoroethylene (PCTFE) and/or polyvinylidene fluoride (PVDF). Here, in principle in each case, alternatively to the named materials, it is also possible to provide other thermoplastically processable materials that contain fluoropolymers and that have a melting point or melting range between 170° C. and 320° C.

Here, tetrafluoroethylene perfluoropropylene (FEP) is understood in particular as the chemical substance having the structural formula [—CF2-CF2-CF(CF3)-CF2-]n.

Tetrafluoroethylene perfluoropropylene (FEP) is here understood in particular as chemical substances that can be produced through polymerization of mixtures of the monomer tetrafluoroethylene (TFE) with a portion differing from zero, in particular differing significantly from zero, of the monomer hexafluoropropylene (HFP).

Here, perfluoroalkoxy polymers (PFA) are understood in particular as chemical substances that can be produced through polymerization of mixtures of the monomer tetrafluoroethylene (TFE) with a portion differing from zero, in particular differing significantly from zero, of the monomer perfluoropropylvinyl ether (PPVE). Here, perfluoroalkoxy polymers (PFA) are understood in particular as chemical substances having the structural formula [—CF2-CF2-CF(OR)—CF2-]n, where the side group OR is at least one alkoxy group. In particular, these are fully fluorinated polymers having at least one alkoxy side chain. Perfluoroalkoxy polymers (PFA) are in particular chemical substances that are thermoplastically processable, can wet ceramic, oxidic, glass, and/or metal surfaces, and/or can be fused with polytetrafluoroethylene (PTFE). The present invention includes in particular various PFA qualities and/or mixtures of different PFA qualities, so-called PFA polyblends. In connection with the present invention, applicant has had particularly positive experiences with the use of PFA polyblends whose melting range is between 260° C. and 320° C., in particular extending from 260° C. to 320° C. Polymers having a molar mass of 3*10̂5 to 3*10̂6 g/mol are preferred.

Here, polychlorotrifluoroethylene (PCTFE) is understood in particular as the chemical substance having the structural formula [—CFC1-CF2-]n.

Here, polyvinylidene fluoride (PVDF) is understood in particular as the chemical substance having the structural formula [—CH2-CF2-]n.

In order to retain an overall elastic basic characteristic of the stopper, it can be advantageous if the outer seal and/or the material of which the outer seal is made contributes only to a small degree to the mass and/or to the volume of the stopper. In particular, it can be advantageous if the outer seal and/or the material of which the outer seal is made makes up at most 20% or at most 15%, preferably even at most 10% or at most 5%, of the mass of the stopper. In addition or alternatively, it can also be advantageous if the outer seal and/or the material of which the outer seal is made makes up at most 20% or at most 15%, preferably even at most 10% or at most 5%, of the volume of the stopper.

In particular, it is possible that the outer seal is situated on the basic body in the form of an outward-oriented layer; here, in particular layer thicknesses of at least 10 μm, preferably at least 50 μm, have proven successful, because in this way a reliable formation of the outer sealing layer is ensured. Here, a layer thickness that should not be exceeded is 1 mm, preferably 250 μm. In particularly temperature-critical applications, a layer thickness between 50 μm and 150 μm can also be preferred, in particular if a fluctuation of the actual layer thickness of 20%, preferably 15%, is not exceeded.

In principle it is possible, and is within the scope of the present invention, that a materially bonded connection between the outer seal and the basic body is not yet brought about at the production facility, or is not completely brought about there, and in particular can be formed, or can be completely formed, during operation of the sensor, for example through separate heating of the sensor and/or as a consequence of the charging of the exhaust gas sensor with hot exhaust gas. In an advantageous specific embodiment of the present invention, the creation of this material bond is however already integrated into the production process, so that a stopper, or an exhaust gas sensor, is then present in which the basic body is connected to the outer seal completely or partly with a material bond, and in which an optimized sealing effect is present already at the beginning of the intended operation of the sensor.

A materially bonded connection is a connection in which a holding together of the joining partners takes place through forces that become effective at the molecular level, as defined in particular also in VDI Guideline 2232-2004-01.

Examples of materially bonded connections include welding, gluing, fusing, etc. The materially bonded connection can in particular be an immediate materially bonded connection between two joining partners in which there is an immediate interaction between the two joining partners at the molecular level. On the other hand, the materially bonded connection can also be an indirect materially bonded connection in which the two joining partners are not connected immediately to one another with a material bond, but rather each are connected immediately with a material bond to at least one third joining partner, and in the case of a plurality of third joining partners, all of these third joining partners are connected (indirectly or immediately) to one another with a material bond.

The stopper according to the present invention has a through-channel, in particular an axial one, for the guiding through of a connecting cable. This means that the through-channel is fundamentally made such that a connecting cable can be led through the stopper, preferably through the stopper from the interior of the housing into an area situated outside the housing.

A development of the present invention provides that the stopper includes a connecting cable that is led through the stopper, preferably through the stopper from the interior of the housing into an area situated outside the housing.

In the present context, an exhaust gas sensor is to be understood in particular as a lambda sensor for use in the exhaust train of an internal combustion engine, but it can also be some other sensor, such as a temperature sensor or an NOx or rust particle sensor or the like. In particular, the scope of the present invention includes all sensors suitable for long-term use at high temperatures and/or in an aggressive environment, and sensors in which a for example electrical connecting line is to be led out from a housing that is to be sealed, in particular where there are comparatively high ambient temperatures.

Preferably, the provision of the measures according to the present invention results in a tightness at the connection side of the housing of the exhaust gas sensor that is comparatively high, for example a helium tightness of less than 10̂-3 mbar*l/s or 10̂-4 mbar*l/s, preferably even a helium tightness of less than 10̂-5 mbar*l/s or 10̂-6 mbar*l/s. On the other hand, the terms “seal,” “sealed,” etc. also should not be interpreted too narrowly, so that in particular a merely macroscopic seal can also be included. A leak that may remain through the interior of a tube-shaped insulation of the connecting cable, or the connecting cables, is also not under consideration in the present case, because this leak can be sealed elsewhere, for example at a plug connected to the connecting cable and to the connecting cables. It is also possible to lead out such a leak through the connecting cable or cables into a non-critical area, for example a colder, less exposed region of a motor vehicle. An absolute or hermetic tightness (in particular helium tightness less than 10̂-10 mbar*l/s) is possible in principle, but, with the exception of special applications, is prohibitively expensive.

In order to achieve a comparatively high tightness of the housing, it is preferred in particular that the housing of the exhaust gas sensor is connected to the outer seal with a material bond.

Preferred developments of the present invention result from the fact that the basic idea of the sealing between the basic body of the stopper and the housing of the exhaust gas sensor is carried over, through the provision of the outer seal according to the present invention, to the seal between the basic body of the stopper and the connecting line.

Thus, as a development it can be provided that a seal is situated at least at some locations between the basic body of the stopper and the through-channel, the seal having at least one perfluoroalkoxy polymer (PFA) or a tetrafluoroethylene perfluoropropylene (FEP) or a polychlorotrifluoroethylene (PCTFE) or a polyvinylidene fluoride (PVDF) or some other thermoplastically processable fluoropolymer-containing material having a melting point or melting range between 170° C. and 320° C. In addition, the basic body can be connected to the seal with a material bond. In addition or alternatively, the seal can be situated on the basic body in the form of a layer oriented toward the through-channel, preferably having a layer thickness of from 10 μm to 1 mm, particular preferably a layer thickness of from 50 μm to 250 μm.

Thus, in addition or alternatively it can be provided that a connecting cable of the exhaust gas sensor is connected to the seal with a material bond. In addition or alternatively, it can be provided that the connecting cable has an electrical conductor that is surrounded by an insulation that has in particular a fluoropolymer, for example polytetrafluoroethylene (PTFE) or a fluoroelastomer, or is made of such a fluoropolymer, in particular completely, predominantly, or partly. In order to optimize the tightness and the temperature resistance, it is particularly preferable if the insulation of the connecting cable is made of the same material as the basic body of the stopper, for example of polytetrafluoroethylene (PTFE) or of a fluoroelastomer.

The electrical conductor of the connecting cable is preferably provided by copper and/or copper-steel braids.

It can be provided in particular that for the outer seal and for the seal the same material is provided, in particular a material having the same chemical composition. The layer thicknesses provided for the seal and for the outer seal can also agree with one another.

In order to achieve a comparatively high tightness of the housing, it is in particular preferred that the connecting cable, the stopper, and the housing are connected to one another with a material bond, i.e. in particular a material bond is realized between the housing and the stopper and a material bond is realized between the stopper and the connecting cable, in particular between the stopper and an insulation of the connecting cable. In particular, an overall materially bonded sealing of the connection-side end of the housing of the exhaust gas sensor is realized.

Methods according to the present invention for producing a stopper, in particular a stopper according to the present invention, and/or an exhaust gas sensor, in particular an exhaust gas sensor according to the present invention, provide that a basic body having a fluoroelastomer, in particular made of a fluoroelastomer, is provided. In addition, it is provided that an outer sealing material is provided having at least one perfluoroalkoxy polymer (PFA) or a tetrafluoroethylene perfluoropropylene (FEP) or a polychlorotrifluoroethylene (PCTFE) or a polyvinylidene fluoride (PVD) or some other thermoplastically processable fluoropolymer-containing material having a melting point or melting range between 170° C. and 320° C.

The outer sealing material can in particular be at least one tube, in particular a tube that is pushed onto the basic body, drawn onto the basic body, or rolled onto the basic body. The length of the tube in the axial direction is preferably greater than half its diameter or greater than its diameter. Preferred are tubes having a wall thickness of from 10 μm to 1 mm, particularly preferably having a wall thickness of 50-250 μm.

The outer sealing material can also be at least one film, in particular a film wound onto or around the basic body. Preferred are films having a wall thickness of from 10 μm to 1 mm, preferably having a wall thickness of 50-250 μm.

The outer sealing material can on the other hand also have an annular shape. The sealing material can then in particular be pushed onto the basic body or rolled onto the basic body in the provided position. The length of the ring in the axial direction is preferably equal to or less than half its diameter. Preferred are rings having a wall thickness of from 10 μm to 1 mm, particularly preferably having a wall thickness of 50-250 μm.

In principle, the outer sealing material can also be applied in other ways. For example, it can be sprayed onto the basic body in a liquid state. Another alternative is to bring outer sealing material into contact first with the housing-side sealing surface, for example to spray it into the housing-side sealing surface.

Essential for the method according to the present invention is the situation of the outer sealing material and of the basic body inside a housing, so that outer sealing material is situated between the basic body and the housing. In particular, subsequently the overall outer seal, or only a part of the outer seal, is situated between the basic body and housing.

It is in particular provided that the assembly made up of the basic body, outer sealing material, and housing is heated and caulked at the production facility. Here, this produces in particular a melting on of the outer sealing material, and subsequently in particular a materially bonded connection between the housing and the stopper, in particular between the housing and the outer seal, and/or between the outer seal and the basic body of the stopper. Alternatively, it is possible for the heating of the assembly made up of the basic body, outer seal, and housing not to take place at the production facility, but rather in particular to take place only upon commissioning of the sensor. Here as well, a materially bonded connection can then result between the housing and the stopper, in particular between the housing and the outer seal and/or between the outer seal and the basic body of the stopper.

Heating to a temperature of 285° C. to 325° C. is preferred, and moreover it is preferred that heating to higher temperatures is not done. In particular, the stopper is not heated to more than 320° C.

It is in particular provided that the assembly made up of the basic body, sealing material, and housing is caulked by a pressure applied externally, in particular 700 to 2000 N/cm̂2. The caulking can in particular take place at the same time as the heating. In particular, the formation of a materially bonded connection between the housing and the stopper can take place during the caulking.

Preferred developments of the production method according to the present invention result from the fact that through the provision of the outer seal according to the present invention, the sealing between the basic body of the stopper and the housing of the exhaust gas sensor is carried over to the sealing between the basic body of the stopper and the connecting line.

Thus, it can be provided that in addition to the outer seal between the basic body of the stopper and the housing of the exhaust gas sensor, the above-explained seal between the basic body of the stopper and the connecting line is also produced. For this purpose, a connecting cable, having radially externally as sealing material at least one perfluoroalkoxy polymer or a tetrafluoroethylene perfluoropropylene or a polychlorotrifluoroethylene or a polyvinylidene fluoride or some other thermoplastically processable fluoropolymer-containing material having a melting point or melting range between 170° C. and 320° C. is led through the through-channel of the basic body, so that the sealing material enters into the through-channel.

In particular, an assembly made up of housing, external seal, basic body, sealing material of the seal, and connecting cable is produced, and the entire assembly is heated and caulked together, in particular by an externally applied pressure of from 700 to 2000 N/cm̂2.

In addition, during this heating it can be provided that in addition to the outer sealing material, in particular at the same time, the sealing material also at least partly melts on, and subsequently a materially bonded connection is formed between the basic body, the sealing material, and the connecting cable.

It is particularly advantageous if the sealing material that is to be used agrees with the external sealing material that is to be used with regard to its chemical composition and its handling. For example, the sealing material and outer sealing material can both be processed in the form of melting films having a thickness of from 100 μm to 200 μm.

### BRIEF DESCRIPTION OF THE DRAWINGS

FIGS. 1a and 1b, 2a and 2b, 3a and 3b, and 4a and 4b, in each case in a top view, and along a section along a longitudinal axis of the stopper, show example embodiments of the stopper according to the present invention.

FIG. 5 shows an exhaust gas sensor according to the present invention.

### DETAILED DESCRIPTION OF THE INVENTION

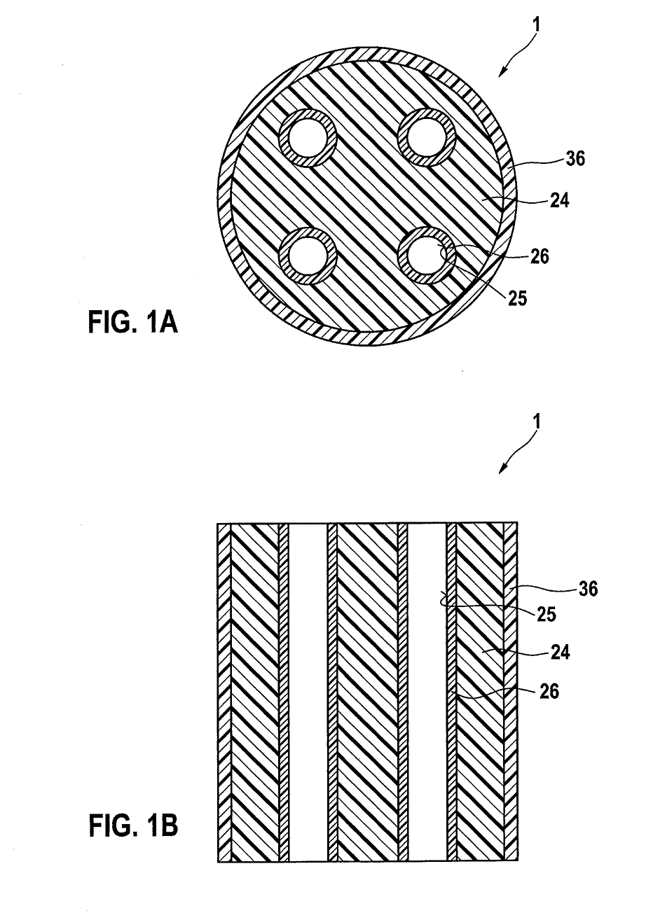

FIGS. 1a and 1b show a first exemplary embodiment of a stopper 1 according to the present invention in a top view, or in a section along the longitudinal axis of stopper 1.

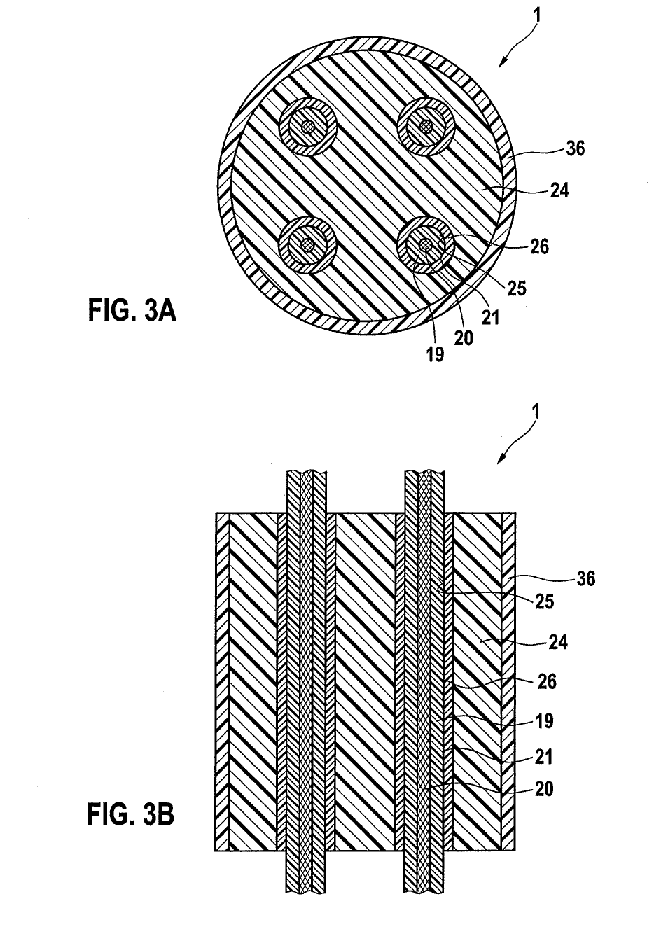

Stopper 1 has a cylindrical shape or basic shape, and has in particular the shape or basic shape of a right circular cylinder. A basic body 24 situated radially inwardly also has a cylindrical shape or basic shape, and in particular has the shape or basic shape of a right circular cylinder. Basic body 24 can for example have a length of 15 mm and a diameter of 10 mm. Stopper 1 or basic body 24 have for example four axial through-channels 25 that extend in the longitudinal direction and that have for example a diameter of 1 mm. In this exemplary embodiment of a stopper 1 according to the present invention, through-channels 25 are open and are provided for the guiding through of a respective connecting cable 21 (see FIGS. 3 through 5). On the inner contours of basic body 24, i.e. radially outwardly limiting through-channels 25, there is fashioned a respective seal 26, over the entire surface, in the form of a layer that is for example 100 μm thick. Radially outwardly, on the jacket surface of basic body 24 there is attached an outer seal 36, also over the entire surface, in the form of a layer that is for example 100 μm thick.

In this example, basic body 24 is made up of fluororubber or perfluororubber, and makes up more than 95% of the volume or of the mass of stopper 1, so that there results a high thermal stability and elasticity of stopper 1. In this example, the material of seal 26 and of outer seal 36 is in each case a perfluoroalkoxy polymer (PFA) having a melting range of from 260° C.-320° C. Alternatively, the material of seal 26 and of outer seal 36 is one of the following materials: perfluoroalkoxy polymer (PFA), tetrafluoroethylene perfluoropropylene (FEP), polychlorotrifluoroethylene (PCTFE), polyvinylidene fluoride (PVD), or some other thermoplastically processable fluoropolymer-containing material having a melting point or melting range between 170° C. and 320° C. Other materials that contain the named materials only in part, and/or mixtures of the named materials, are also possible in principle.

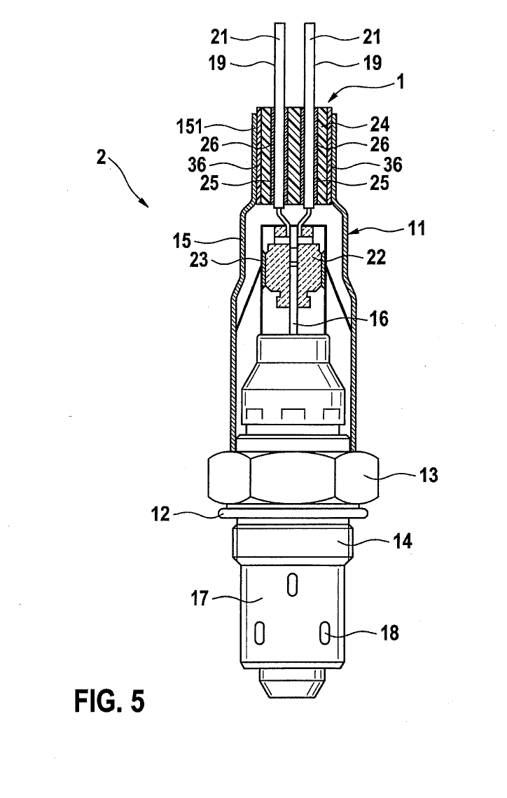

It is provided that through stopper 1 according to the present invention, a housing 11 of an exhaust gas sensor 2 (see FIG. 5) is capable of being sealed, basic body 24 of stopper 1 being capable of being sealed relative to a connecting cable 21 by seal 26, and basic body 24 of stopper 1 being capable of being sealed relative to housing 11 of exhaust gas sensor 2 by outer seal 36.

In order to improve the sealing effect of seal 26, or of outer seal 36, in this example it is provided that seal 26 and basic body 24 are connected to one another with a material bond by melting, and that outer seal 36 and basic body 24 are connected to one another with a material bond by melting. In particular, it is provided that the melting results in a melting, or melting on, of the material of seal 26 or of outer seal 36. In particular, it is provided that the melting does not result in a melting or melting on or a chemical decomposition of the material of basic body 24.

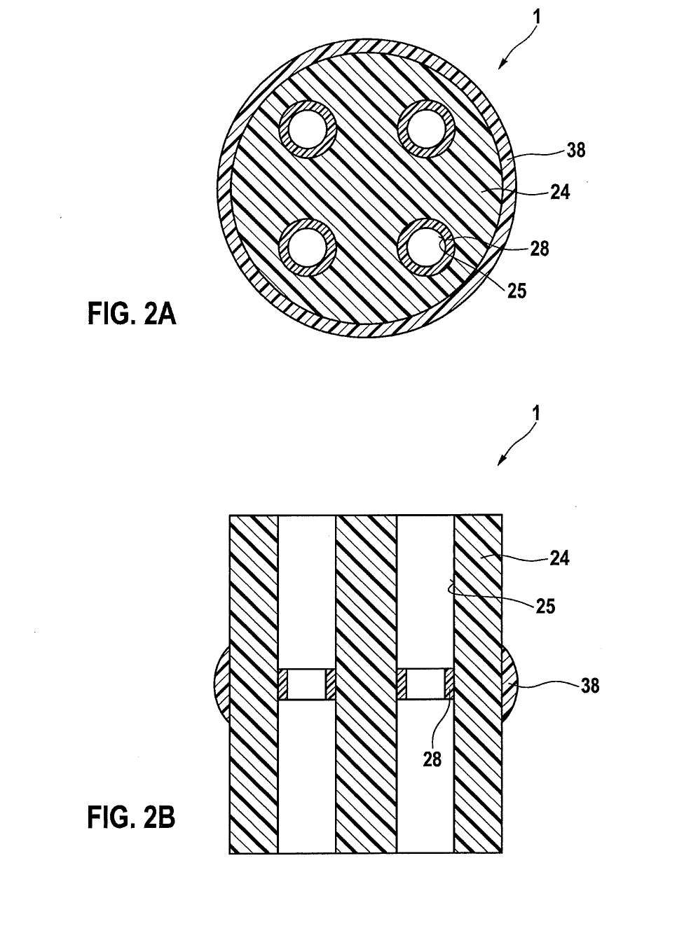

FIGS. 2a and 2b show a second exemplary embodiment of a stopper 1 according to the present invention in a top view, or in a section along the longitudinal axis of stopper 1.

The second exemplary embodiment differs from the first exemplary embodiment in that seal 26 is not fashioned as a full-surface layer on the inner contour of basic body 24, but rather is situated as a sealing ring 28 on the inner contour of the basic body and covers the basic body only partly in its longitudinal extension. Sealing ring 28 has a length (longitudinal direction of through-channel 25) of 1 mm and a thickness (radial direction) of 150 μm or 250 μm.

Moreover, the second exemplary embodiment differs from the first exemplary embodiment in that outer seal 36 is not fashioned radially outwardly on basic body 24 as a full-surface layer, but rather is situated radially outwardly on basic body 24 as outer sealing ring 38, and covers the outer surface of basic body 24 only partly in its longitudinal extension. Outer seal 38 has a length (longitudinal direction of basic body 24) of 3 mm and a thickness (radial direction) of 250 μm or 600 μm.

In this example, sealing ring 28 and outer sealing ring 38 are situated approximately centrically, in particular centrically, in the longitudinal direction of stopper 1. In alternatives of the exemplary embodiment, it can also be provided that sealing ring 28 and/or outer sealing ring 38 are situated eccentrically. In particular the provision of two sealing rings 28 and/or to outer sealing rings 38, situated opposite one another when viewed in the longitudinal direction of stopper 1, is possible. It is also possible in principle to provide still more sealing rings 28 and/or outer sealing rings 38.

FIGS. 3a and 3b show a third exemplary embodiment of a stopper 1 according to the present invention in a top view, or in a section along the longitudinal axis of stopper 1.

In a development of the present invention, for example according to the first or second exemplary embodiment, a stopper 1 is provided in which at least one connecting cable 21 is situated in through-channel 25, or at least one connecting cable 21 is led through its through-channel 25, so that the stopper is in particular suitable for sealing housing 11 of an exhaust gas sensor 2.

In the present case, connecting cable 21 is made up of an electrical conductor 20 that is fashioned in particular as copper braid or steel-copper braid, electrical conductor 20 being surrounded in particular by an insulation 19, in particular being surrounded by insulation 19 along the entire length of stopper 1. Alternatively, it would also be possible for electrical conductor 20 to be surrounded by insulation 19 only along a part of stopper 1, and to be situated immediately opposite seal 26 and/or sealing ring 28 and/or basic body 24 of stopper 1 along a part of stopper 1.

It can be provided that connecting cable 21, in particular insulation 19, is connected with a material bond to seal 26 and/or to sealing ring 28, in particular is fused therewith, in particular by melting on of the material provided for seal 26 or sealing ring 28.

Alternatively, however, it can also be provided that connecting cable 21, in particular insulation 19, is not connected with a material bond to seal 26 and/or sealing ring 28, but rather is merely fastened, in particular with a non-positive fit, in the interior of seal 26 and/or sealing ring 28, or in the interior of basic body 24. In this case, however, it is preferred that connecting cable 21, in particular insulation 19, can be connected with a material bond to seal 26 and/or to sealing ring 28, in particular by welding.

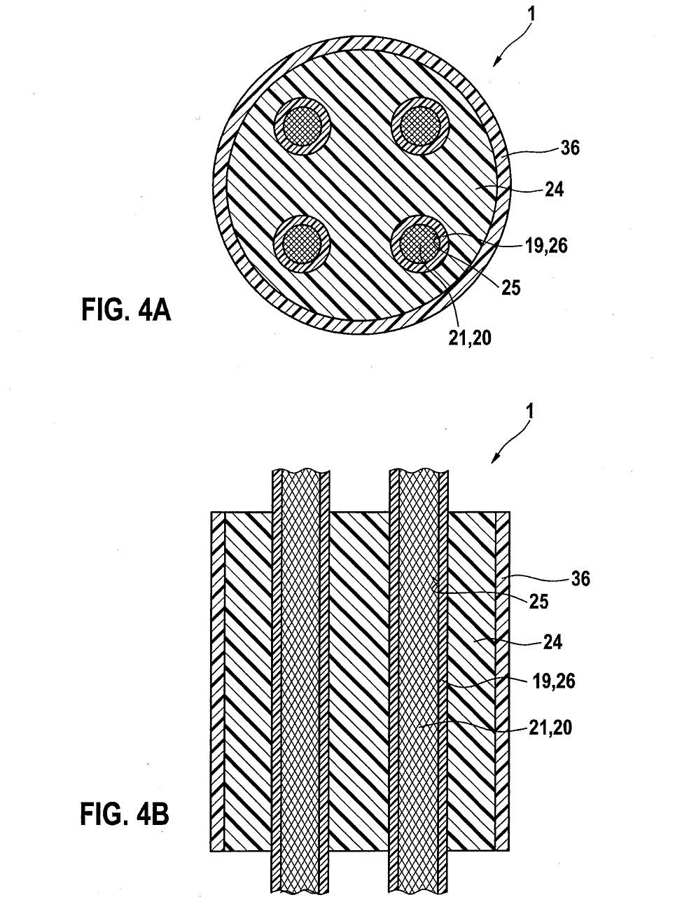

FIGS. 4a and 4b show a fourth exemplary embodiment of a stopper 1 according to the present invention in a top view, or in a section along the longitudinal axis of stopper 1.

In a development of the present invention, for example according to the first or second exemplary embodiment, this is a stopper 1 in which at least one connecting cable 21 is situated in through-channel 25, or through whose through-channel 25 there is led at least one connecting cable 21, so that stopper 1 is in particular suitable for sealing housing 11 of an exhaust gas sensor 2.

Differing from the third exemplary embodiment, it is provided that insulation 19 of connecting cable 21 and seal 26 are not fashioned as parts differing from one another; rather, seal 26 at the same time takes over the function of insulation 19 of electrical conductor 20 and is situated opposite it, in particular immediately opposite.

In this example, seal 26 or insulation 19 is led out from stopper 1, in particular at two sides or at one side, together with electrical conductor 20, and insulates electrical conductor 20 of connecting cable 21 outside stopper 1 as well, for example up to a part (not shown) of a plug connection, for example a plug that is connected to connecting cable 21 at the side of connecting cable 21 situated opposite stopper 1, and that can be connected, in particular plugged together, for example with a part of the plug connection that is part of a control device, for example a socket.

In this example, insulation 19, which inside stopper 1 at the same time forms insulation 26, is fashioned as a 250 μm-thick layer of perfluoroalkoxy polymer (PFA) that radially outwardly surrounds the electrical conductor in the form of an insulating tube.

In this example, it can be provided that insulation 19, i.e. in the present case seal 26, is connected with a material bond, in particular fused, to conductor 20 of connecting cable 21 and/or to basic body 24 of stopper 1, in particular by melting on of the material provided for insulation 19, i.e. in the present case seal 26.

However, alternatively it can also be provided that insulation 19, i.e. in the present case seal 26, is not connected with a material bond to conductor 20 of connecting cable 21 and/or to basic body 24 of stopper 1, but rather insulation 19, i.e. in the present case seal 26, is merely fastened, in particular with a non-positive fit, to conductor 20 of connecting cable 21 and/or to basic body 24 of stopper 1. However, in this case it is in particular preferred that insulation 19, i.e. in the present case seal 26, is capable of being connected with a material bond, in particular by welding, to conductor 20 of connecting cable 21 and/or to basic body 24 of stopper 1.

In alternatives of the exemplary embodiment, it can also be provided that insulation 19, which at the same time forms insulation 26 inside stopper 1, is not made up of perfluoroalkoxy polymer (PFA), but rather is made up of a material that includes at least one perfluoroalkoxy polymer (PFA) or a tetrafluoroethylene perfluoropropylene (FEP) or a polychlorotrifluoroethylene (PCTFE) or a polyvinylidene fluoride (PVDF) or some other thermoplastically processable fluoropolymer-containing material having a melting point or melting range between 170° C. and 320° C.

The fourth exemplary embodiment is in particular also an exemplary embodiment of a stopper 1 for sealing housing 11 of an exhaust gas sensor 2, stopper 1 having a basic body 24 that has a fluoroelastomer, stopper 1 having at least one axial through-channel 25 through which an electrical conductor 20 is led, an insulating seal 26 being situated at least at some locations between basic body 24 of stopper 1 and through-channel 25, the insulating seal being led out together with electrical conductor 20 from stopper 1 at at least one side, i.e. in particular at an end face of stopper 1, insulating seal 26 having at least one thermoplastically processable fluoropolymer-containing material having a melting point or melting range between 170° C. and 320° C., in particular a perfluoroalkoxy polymer or a tetrafluoroethylene perfluoropropylene or a polychlorotrifluoroethylene or a polyvinylidene fluoride. Here, insulating seal 26 is situated opposite, in particular immediately opposite, electrical conductor 20 and basic body 24, and is connected or is capable of being connected in particular to electrical conductor 20 and/or with basic body 24, in particular inside through-channel 25, in particular with a material bond, in particular by welding, or is capable of being so welded.

Further exemplary embodiments of the present invention relate to exhaust gas sensors 2 having a stopper 1 as presented in more detail above, in particular in the first, second, third, and fourth exemplary embodiment. These exhaust gas sensors 2 each have at least one housing 11 that is sealed by stopper 1 and at least one connecting cable 21 that is led through through-channel 25 of stopper 1.

As a further exemplary embodiment of the present invention, FIG. 5 shows an exhaust gas sensor 2 whose part situated at the exhaust gas side of stopper 1 is known in principle from the existing art and is designed for example as a part of a lambda sensor for measuring the oxygen concentration in the exhaust gas of internal combustion engines. This exhaust gas sensor 2 has a housing 11 that is made up of a massive housing body 12 made of metal having a screw threading 14 and having a mounting hexagonal part 13, and having a protective sleeve 15 that is pushed onto housing body 12 and connected fixedly therewith, the protective sleeve having an end segment 151 that is remote from the housing body and is for example reduced in diameter. In housing 11 there is situated for example a sensor element 16 whose end at the measurement gas side extends from housing 11 and is covered there by a protective tube 17 having gas passage holes 18, the protective tube being fastened on housing body 12. At the end at the connection side, opposite the end at the measurement gas side, sensor element 16 has contact surfaces that are connected to measurement electrodes situated at the measurement gas side end. At the contact surfaces, the electrical conductors 20, for example surrounded by an insulation 19, are contacted by connecting cables 21. In this exemplary embodiment, for the contacting of contact surfaces and of electrical conductors 20 a two-part ceramic clamping body 22 is provided that is externally surrounded by a spring element 23 and that presses electrical conductors 20 onto the contact surfaces of sensor element 16 with a non-positive fit. Ceramic clamping body 22 is supported radially on protective sleeve 15.

Alternatives to this part of an exhaust gas sensor 2, situated at the exhaust gas side of a stopper 1 and explained as an example, are possible in principle and/or are also known from the existing art.

In the further exemplary embodiments, it is provided that stopper 1 closes or seals housing 11 by being situated in the part of protective sleeve 15 facing away from housing body 12, in particular in an end segment 151 of protective sleeve 15 remote from the housing body.

Stopper 1 can for example, as shown in FIG. 5, be the stopper 1 explained in connection with the third exemplary embodiment of the present invention (FIG. 3). Alternatively, it can also be a stopper 1 as explained in connection with the first, second, and/or fourth exemplary embodiment (FIGS. 1, 2, and 4).

In the further exemplary embodiments, it can be provided that outer seal 36 is connected with a material bond, in particular fused, to basic body 24 of stopper 1 and/or to housing 11, in particular with protective sleeve 15 and/or end segment 151, remote from the housing body, of protective sleeve 15, in particular by melting on of the material provided for outer seal 36.

Alternatively, in the further exemplary embodiments it can however also be provided that outer seal 36 is not connected with a material bond to basic body 24 of stopper 1 and/or to housing 11, in particular with protective sleeve 15 and/or with end segment 151, remote from the housing body, of protective sleeve 15, but rather that outer seal 36 is merely fastened, in particular with a non-positive fit, to basic body 24 of stopper 1 and/or to housing 11, in particular with protective sleeve 15 and/or with end segment 151, remote from the housing body, of protective sleeve 15. In this case, however, it is in particular preferred that outer seal 36 can be connected with a material bond, in particular welded, to basic body 24 of stopper 1 and/or to housing 11, in particular with protective sleeve 15 and/or with end segment 151, remote from the housing body, of protective sleeve 15.

An exemplary embodiment of the method according to the present invention for producing an exhaust gas sensor 2 provides that a basic body 24 that has a fluoroelastomer and that has at least one through-channel 25 is provided, and that a connecting cable that has, radially externally, a sealing material, for example in the form of a 150 μm-thick film, having at least one thermoplastically processable material that contains fluoropolymer and has a melting point or melting range between 170° C. and 320° C., in particular a perfluoroalkoxy polymer or a tetrafluoroethylene perfluoropropylene or a polychlorotrifluoroethylene or a polyvinylidene fluoride, is led through through-channel 25. It is further provided that this assembly of basic body 24 and connecting cable 21 together with an outer sealing material, for example a 150 μm-thick film that has at least one thermoplastically processable fluoropolymer-containing material having a melting point or melting range between 170° C. and 320° C., in particular a perfluoroalkoxy polymer or a tetrafluoroethylene perfluoropropylene or a polychlorotrifluoroethylene or a polyvinylidene fluoride, is situated in the interior of a housing 11, so that outer sealing material is situated between basic body 24 and housing 11. In this example it is provided that the situation is carried out in an end segment 151, remote from the housing body, of a protective sleeve 15 that can be mounted with a housing body 12 to form a housing 11.

It is in particular provided that through caulking and heating of the assembly made up of connecting cable 21, sealing material, basic body 24, outer sealing material, and housing 11 or protective sleeve 15, a sealing, in particular a complete sealing, with a material bond of housing 11 or protective sleeve 15 is created. In particular, a fusing takes place through melting of the sealing material and of the outer sealing material.

In the example, the caulking takes place with an applied pressure of from 700 to 2000 N/cm̂2. The heating of the assembly made up of connecting cable 21, sealing material, basic body 24, outer sealing material, and housing 11 preferably takes place over a period of time of 10 seconds or more, preferably 30 seconds or more, so that a melting of the sealing material or of the outer sealing material reliably takes place.

Furthermore, in this example it is provided that the heating is carried out up to a temperature that is above the melting temperature of the sealing material or of the outer sealing material, i.e. for example over 280° C. for perfluoroalkoxy polymer (PFA), over 240° C. for tetrafluoroethylene perfluoropropylene (FEP), over 190° C. for polychlorotrifluoroethylene (PCTFE), over 170° C. for polyvinylidene fluoride (PVDF), so that a melting of the sealing material or of the outer sealing material reliably takes place. During the heating, particular care is to be taken that the temperature of the basic body does not exceed 327° C. In this way, a chemical decomposition of the basic body and thus damage, in particular irreversible, to stopper 1 is reliably avoided.

1-16. (canceled)

17. A stopper for sealing a housing of an exhaust gas sensor, comprising:
a basic body containing a fluoroelastomer;
at least one axial through-channel provided in the basic body for guiding through a connecting cable; and
at least one outer seal situated radially externally on the basic body, wherein the at least one outer seal contains at least one thermoplastically processed fluoropolymer-containing material having a melting point between 170° C. and 320° C.

18. The stopper as recited in claim 17, wherein the fluoroelastomer is one of a fluororubber or a perfluororubber.

19. The stopper as recited in claim 18, wherein the material containing fluoropolymer has at least one of a perfluoroalkoxy polymer, a tetrafluoroethylene perfluoropropylene, a polychlorotrifluoroethylene, and a polyvinylidene fluoride.

20. The stopper as recited in claim 19, wherein the basic body is connected to the at least one outer seal by a material bond.

21. The stopper as recited in claim 19, wherein the at least one outer seal is a layer having a layer thickness between 50 μm and 250 μm.

22. An exhaust gas sensor, comprising:
a housing;
a stopper which seals the housing, wherein the stopper includes:
a basic body containing a fluoroelastomer;
at least one axial through-channel provided in the basic body; and
at least one outer seal situated radially externally on the basic body, wherein the at least one outer seal contains at least one thermoplastically processed fluoropolymer-containing material having a melting point between 170° C. and 320° C.; and
at least one connecting cable led through the through-channel of the stopper.

23. The exhaust gas sensor as recited in claim 22, wherein the housing is connected to the stopper indirectly via the at least one outer seal, with a material bond.

24. The exhaust gas sensor as recited in claim 22, wherein an inner seal is provided in the at least one axial through-channel, and wherein the connecting cable, the inner seal, and basic body are connected to one another at least indirectly with a material bond.

25. The exhaust gas sensor as recited in claim 22, wherein the connecting cable has an electrical conductor surrounded by an insulation containing a fluoropolymer.

26. The exhaust gas sensor as recited in claim 22, wherein the connecting cable, the stopper, and the housing are connected to one another at least indirectly with a material bond.

27. A method for producing an exhaust gas sensor, comprising:
providing a basic body of a stopper, wherein the basic body contains a fluoroelastomer, and wherein the basic body has at least one axial through-channel;
providing an outer sealing material, wherein the outer seal contains at least one thermoplastically processable fluoropolymer-containing material having a melting point between 170° C. and 320° C.;
providing a housing;
positioning the outer sealing material and the basic body in the interior of the housing so that the outer sealing material is situated between the basic body and the housing to form an outer assembly; and
caulking and heating the outer assembly made up of the basic body, the outer sealing material, and the housing to form a structure which is at least indirectly materially bonded.

28. The method as recited in claim 27, wherein the outer sealing material is provided by spraying onto the basic body.

29. The method as recited in claim 28, wherein the outer sealing material is provided in the form of at least one of a tube, a film, and a ring.

30. The method as recited in claim 28, wherein the caulking takes place through an externally applied pressure between 700 and 2000 N/cm².

31. The method as recited in claim 30, wherein the heating takes place in such a way that the outer sealing material melts and forms at least indirectly materially bonded connection among the basic body, the outer sealing material, and the housing.

32. The method as recited in claim 31, wherein the heating takes place in such a way that the fluoroelastomer of the basic body does not exceed (i) a melting temperature of the basic body and (ii) a decomposition temperature of the basic body.
